(19) United States
(12) Patent Application Publication
(10) Pub. No.: US 2021/0397470 A1
(43) Pub. Date: Dec. 23, 2021

(54) METHOD TO ORGANIZE VIRTUAL MACHINE TEMPLATES FOR FAST APPLICATION PROVISIONING

(71) Applicant: VMware, Inc., Palo Alto, CA (US)

(72) Inventors: Jian ZHANG, Beijing (CN); Cheng ZHANG, Beijing (CN); Wenwu PENG, Beijing (CN); Jun WANG, Beijing (CN)

(73) Assignee: VMware, Inc., Palo Alto, CA (US)

(21) Appl. No.: 16/986,115

(22) Filed: Aug. 5, 2020

(30) Foreign Application Priority Data
Jun. 19, 2020 (CN) PCT/CN2020/097048

(51) Int. Cl. G06F 9/455; G06F 16/22

(52) U.S. Cl. CPC G06F 9/45558; G06F 16/2246; G06F 2009/45566; G06F 2009/45583; G06F 2009/4557

(57) ABSTRACT

Virtualized computing instances, such as virtual machines, in a virtualized computing environment are provisioned using a tree-based template structure. The tree-based template structure includes a base node and multiple nodes linked to the base node. Each of the multiple nodes includes at least one component that represents a delta relative to the base node. By matching the requirements and role of a virtualized computing instance to be provisioned with the content(s) of a particular node, the particular node can be selected for cloning/creating the virtualized computing instance.

### CROSS-REFERENCE TO RELATED APPLICATION

The present application (Attorney Docket No. E961) claims the benefit of Patent Cooperation Treaty (PCT) Application No. PCT/CN2020/097048, filed Jun. 19, 2020, which is incorporated herein by reference.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualization computing instances such as virtual machines (VMs) running different operating systems (OSs) may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

In a virtualized computing environment, a VM template is commonly used as a starting point in the provisioning process to generate a VM for consumption by an end user for deploying in various applications. However, current techniques to use VM templates for provisioning VMs are generally inefficient (e.g., consume a large amount of storage and involve a slow/complex provisioning processes).

### BRIEF DESCRIPTION OF DRAWINGS

FIG. 1 is a schematic diagram illustrating an example virtualized computing environment that can implement a method to provision VMs using VM templates;

FIG. 2 is a diagram illustrating a first technique to provision VMs in the virtualized computing environment of FIG. 1;

FIG. 3 is a diagram illustrating a second technique to provision VMs in the virtualized computing environment of FIG. 1;

FIG. 4 is a diagram illustrating a third technique to provision VMs in the virtualized computing environment of FIG. 1;

FIG. 5 is a diagram illustrating an example topology of a tree-based template used in the third technique of FIG. 4;

FIG. 6 is a diagram illustrating the linking of files for a tree-based template used in the third technique of FIG. 4; and

FIG. 7 is a flowchart of an example method to provision VMs using a tree-based template approach.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

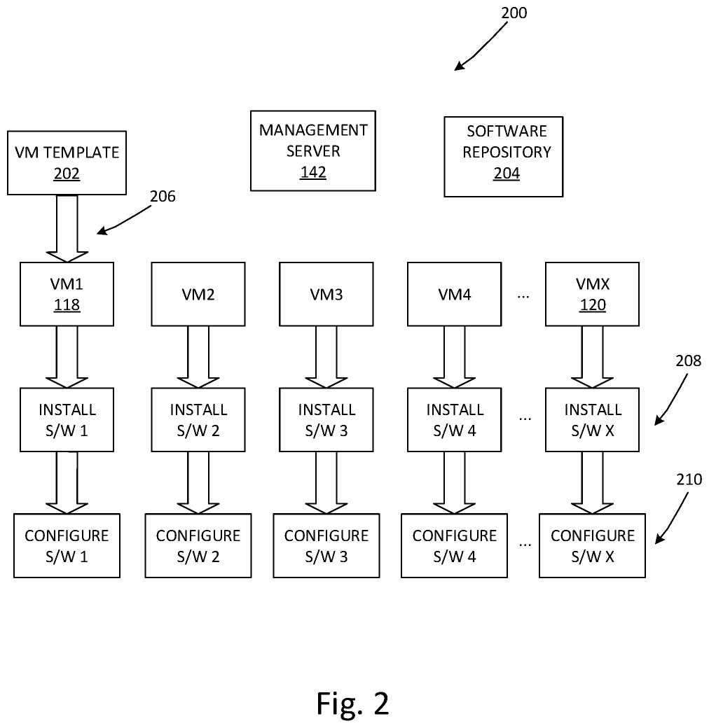

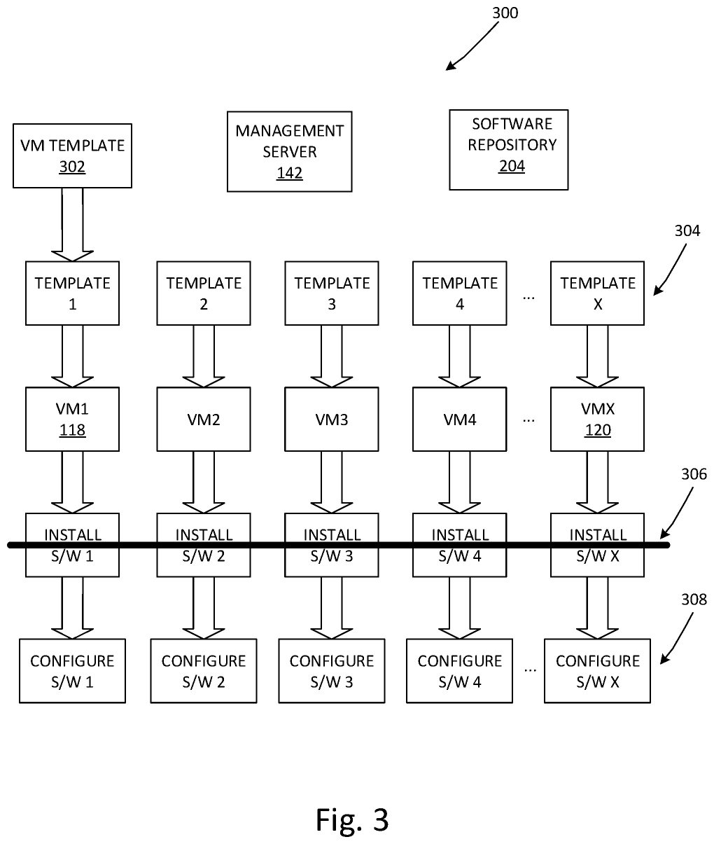

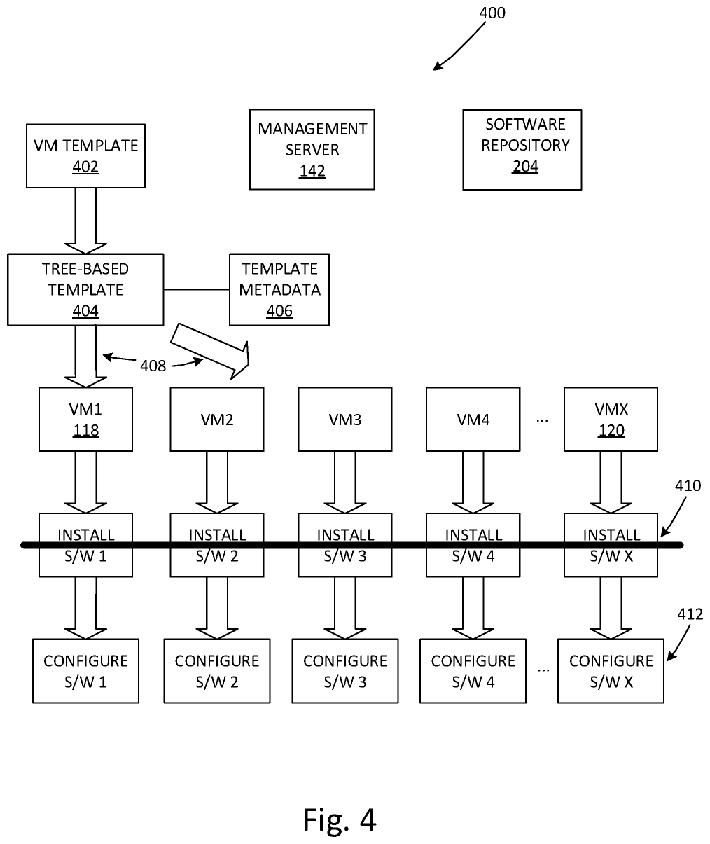

In the present disclosure, various challenges associated with using virtual machine (VM) templates to provision VMs in a virtualized computing environment will be further explained with reference to FIGS. 2 and 3. These challenges may be addressed by using a tree-based structure for VM templates for provisioning VMs, as will be further explained thereafter with respect to FIGS. 4-7.

Computing Environment

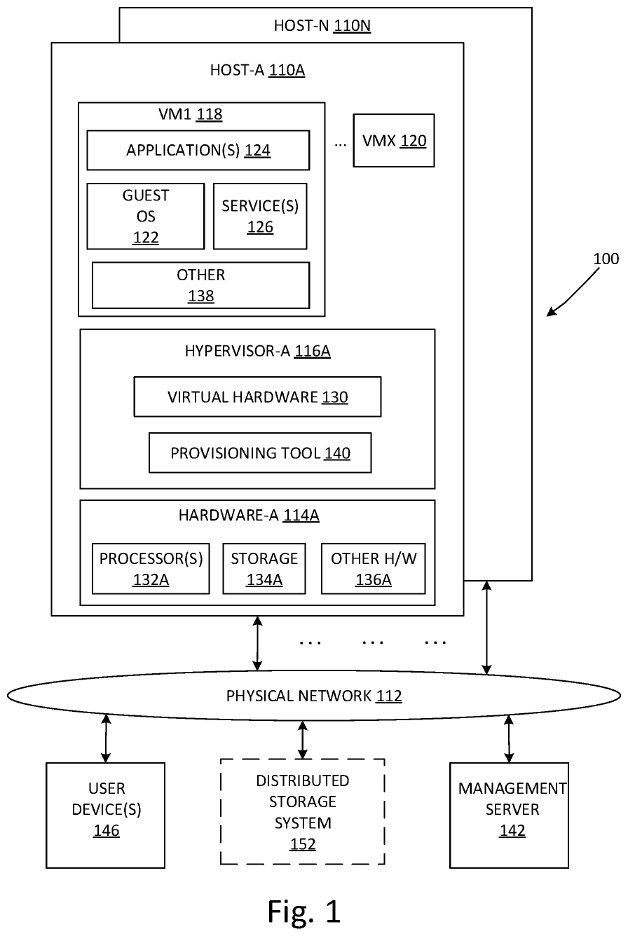

To better understand the use of VM templates in connection with provisioning VMs, various implementations will first be explained in more detail using FIG. 1, which is a schematic diagram illustrating an example virtualized computing environment 100 that can implement a method to provision VMs using VM templates. Depending on the desired implementation, virtualized computing environment 100 may include additional and/or alternative components than that shown in FIG. 1.

In the example in FIG. 1, the virtualized computing environment 100 includes multiple hosts, such as host-A 110A . . . host-N 110N that may be inter-connected via a physical network 112, such as represented in FIG. 1 by interconnecting arrows between the physical network 112 and host-A 110A . . . host-N 110N. Examples of the physical network 112 can include a wired network, a wireless network, the Internet, or other network types and also combinations of different networks and network types. For simplicity of explanation, the various components and features of the hosts will be described hereinafter in the context of host-A 110A. Each of the other hosts can include substantially similar elements and features.

The host-A 110A includes suitable hardware-A 114A and virtualization software (e.g., a hypervisor-A 116A) to support various virtual machines (VMs). For example, the host-A 110A supports VM1 118 . . . VMX 120. In practice, the virtualized computing environment 100 may include any number of hosts (also known as a “computing devices”, “host computers”, “host devices”, “physical servers”, “server systems”, “physical machines,” etc.), wherein each host may be supporting tens or hundreds of virtual machines. For the sake of simplicity and where appropriate, the details of only the single VM1 118 is shown and described herein.

VM1 118 may include a guest operating system (OS) 122 and one or more guest applications 124 (and their corresponding processes) that run on top of the guest operating system 122. VM1 118 may include other installed software elements such as one or more services 126 that reside in VM1 118. Examples of the services 126 may include a database server, a web server, a development environment, etc. that are run by the base OS. VM1 118 may include still further other elements, generally depicted at 138, usable in connection with operating VM1 118.

Typically, the guest OS 122, the applications 124, the services 126, and the other elements 138 may be provisioned for and installed in the VM1 118 using one or more VM templates. A VM template describes the configuration of a virtual machine, including central processing unit (CPU), memory, network, storage, guest operating systems, and other supporting libraries that are necessary to create the virtual machine. For instance, a user (such as an end user) may wish to customize the VM1 118 by starting with a VM template with a guest OS 122 and then selecting particular applications 124, services 126, and other elements 138 to install in the VM1 118 in addition to the guest OS 122. If the user is a system administrator, the system administrator can select a VM template for the guest OS 122 and can then select the elements to install in the VM1 118 in addition to the guest OS 122 so as to provide consistency with other VMs, for security purposes, etc. Further discussions regarding the use of VM templates for provisioning VMs will be provided later below with respect to FIGS. 2, 3, 4, etc.

The hypervisor-A 116A may be a software layer or component that supports the execution of multiple virtualized computing instances. The hypervisor-A 116A may run on top of a host operating system (not shown) of the host-A 110A or may run directly on hardware-A 114A. The hypervisor-A 116A maintains a mapping between underlying hardware-A 114A and virtual resources (depicted as virtual hardware 130) allocated to VM1 118 and the other VMs. The hypervisor-A 116A of some implementations may include a provisioning tool 140 to perform the provisioning/installing of software and other elements in the VMs. In other implementations, the provisioning tool 140 may be located elsewhere in the host-A 110A, located at a virtual machine or a physical machine outside of the host-A 110A, located at a management server 142, located at a user device 146, or located at some other location in the virtualized computing environment 100. The provisioning tool 140 may be in the form of a software tool or other computer-executable code, and may also take the form of a centralized tool or a distributed tool.

Hardware-A 114A includes suitable physical components, such as CPU(s) or processor(s) 132A; storage resources(s) 134A; and other hardware 136A such as memory (e.g., random access memory used by the processors 132A), physical network interface controllers (NICs) to provide network connection, storage controller(s) to access the storage resources(s) 134A, etc. Virtual resources (e.g., the virtual hardware 130) are allocated to each virtual machine to support a guest operating system (OS) and application(s) in the virtual machine, such as the guest OS 122 and the applications 124 in VM1 118. Corresponding to the hardware-A 114A, the virtual hardware 130 may include a virtual CPU, a virtual memory, a virtual disk, a virtual network interface controller (VNIC), etc.

Storage resource(s) 134A may be any suitable physical storage device that is locally housed in or directly attached to host-A 110A, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, integrated drive electronics (IDE) disks, universal serial bus (USB) storage, etc. The corresponding storage controller may be any suitable controller, such as redundant array of independent disks (RAID) controller (e.g., RAID 1 configuration), etc.

A distributed storage system 152 may be connected to each of the host-A 110A . . . host-N 110N that belong to the same cluster of hosts. For example, the physical network 112 may support physical and logical/virtual connections between the host-A 110A . . . host-N 110N, such that their respective local storage resources (such as the storage resource 134A of the host-A 110A and the corresponding storage resource of each of the other hosts) can be aggregated together to form the distributed storage system 152 that is accessible to and shared by each of the host-A 110A . . . host-N 110N. In this manner, the distributed storage system 152 is shown in broken lines in FIG. 1, so as to symbolically represent that the distributed storage system 152 is formed as a virtual/logical arrangement of the physical storage devices (e.g. the storage resource 134A of host-A 110A) located in the host-A 110A . . . host-N 110N. However, in addition to these storage resources, the distributed storage system 152 may also include stand-alone storage devices that may not necessarily be a part of or located in any particular host.

The management server 142 or other management entity of one embodiment can take the form of a physical computer with functionality to manage or otherwise control the operation of host-A 110A . . . host-N 110N, including operations associated with provisioning the VMs using templates. In some embodiments, the functionality of the management server 142 can be implemented in a virtual appliance, for example in the form of a single-purpose VM that may be run on one of the hosts in a cluster or on a host that is not in the cluster of hosts. The management server 142 may be operable to collect usage data associated with the hosts and VMs, to configure and provision VMs, to activate or shut down VMs, to monitor health conditions, to diagnose and remedy operational issues that pertain to health and security, and to perform other managerial tasks associated with the operation and use of the various elements in the virtualized computing environment 100 (including managing the operation/use of the distributed storage system 152 and its stored contents).

The management server 142 may be a physical computer that provides a management console and other tools that are directly or remotely accessible to a system administrator or other user. The management server 142 may be communicatively coupled to host-A 110A . . . host-N 110N (and hence communicatively coupled to the virtual machines, hypervisors, hardware, distributed storage system 152, etc.) via the physical network 112. The host-A 110A . . . host-N 110N may in turn be configured as a datacenter that is also managed by the management server 142. In some embodiments, the functionality of the management server 142 may be implemented in any of host-A 110A . . . host-N 110N, instead of being provided as a separate standalone device such as depicted in FIG. 1.

A user may operate the user device 146 to access, via the physical network 112, the functionality of VM1 118 . . . VMX 120 (including operating the applications 124), the functionality of the management server 142, and/or the functionality of the distributed storage system 152. The user device 146 can be in the form of a computer, including desktop computers and portable computers (such as laptops and smart phones). In one embodiment, the user may be a system administrator that operates the user device 146 to remotely communicate with the management server 142 for purposes of performing operations such as configuring, provisioning, managing, diagnosing, remediating, etc. for the VMs and hosts (including the distributed storage system 152). The user may also be any general user, such as an end user consumer that is using the services (e.g., the application 124) provided by VM1 118.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

Provisioning Using One or More VM Templates

As previously stated above, it is common practice to use a VM template as a starting point to generate a VM. A set of VM templates with preconfigured software installed in it may also be provided to users in some situations. A system administrator can maintain a set of VM templates derived from a common base image (e.g., a common base VM template) with some additional software components in the set of VM templates. FIGS. 2 and 3 illustrate two example techniques to use VM templates to provision VMs.

Referring first to FIG. 2, all VMs can be provisioned from a single base VM template. Specifically, FIG. 2 is a diagram illustrating a first technique 200 to provision VMs (e.g., VM1 118 . . . VMX 120) in the virtualized computing environment 100 of FIG. 1, using a single base VM template 202. The base VM template 202 can be maintained by the management server 142, for example stored in the distributed storage system 152 or in some other storage location in the virtualized computing environment 100. A software repository 204 (also maintained by the management server 142 in the distributed storage system 152 or in some other storage location in the virtualized computing environment 100) contains software components such as descriptions, libraries, code, data, etc. that are usable to customize/build a VM from the base VM template 202. The management server 142 coordinates the provisioning process in the first technique 200.

In operation in the first technique 200, the management server 142 uses (shown at 206) the base template 202 in order to clone/create VM1 118 . . . VMX 120. Next at 208, the management server 142 selects software components (labeled as S/W 1, S/W 2, . . . , S/W X in FIG. 2) from the software repository 204 and installs the selected software components in each respective VM1 118 . . . VMX 120. The particular software components installed in each VM1 118 . . . VMX 120 may be different from one VM to another VM, depending on the particular features, functionality, or other role that is desired for the particular VM. Customized configuration of the installed software components is then performed for each VM at 210.

In addition to the uniqueness and differences between each VM1 118 . . . VMX 120 relative to each other, there may also be some dependencies between these VMs (e.g., dependencies between software components residing at different VMs). Thus, the installation/configuration of the software components at 208 and 210 is complex and typically not entirely parallel between the VMs.

Referring next to FIG. 3, multiple VMs can be provisioned from respective multiple VM templates. Specifically, FIG. 3 is a diagram illustrating a second technique 300 to provision VMs (e.g., VM1 118 . . . VMX 120) in the virtualized computing environment 100 of FIG. 1, using a set of VM templates (shown at 304 as Templates 1, 2, . . . , X) that are obtained from a base VM template 302.

In the second technique 300, the management server 142 starts with the base VM template 302, and then for each VM to be provisioned, selects and places the desired software components (from the software repository 204) into the base VM template 302 in order to generate the set of VM templates 304. That is, the management server 142 creates multiple VM templates from the base VM template 302, places the desired software components in each of the multiple VM templates, and then saves these VM templates (with the software components present therein) as new/unique VM templates in the set of VM templates 304.

Thus, by preparing the multiple VM templates (e.g., the set of VM templates 304 having the software components already baked in) that are used to generate/provision the VM1 118 . . . VMX 120, there is no need to perform a separate installation of the software components into the VMs. The elimination of the installation process is depicted by a line 306 in FIG. 3. Thereafter, customized configuration of the software components in each VM1 118 . . . VMX 120 can be performed at 308.

However, the second technique 300 utilizes substantive disk space (in the distributed storage system 152) for the storage of the VM templates having the baked-in software components. For instance, each VM template in the set of VM templates 304 is derived from the same base VM template 302 (e.g., a base OS template), plus additional software components. Depending on the size of the base OS template, the size of each VM template may vary from one to another. For example, a base OS template may be around 3 GB in size, and each of the VM templates in the set of VM templates 304 may have sizes that vary depending on the software components installed in it, wherein the size of the software components is comparatively small relative to the base OS template.

To further illustrate, assume that the storage requirements of a base OS template is M, and there are X number of sub-templates (e.g., the set of VM templates 304) that are based on the base OS template. Assume further in this illustration that on average, each sub-template adds another 10% in storage use. So, the total storage consumption for the base VM template 302 plus the set of VM templates 304 is M+M*(1+10%)*X.

Clearly, there are many redundancies associated with storing the set of VM templates 304 for use in provisioning VMs in the second technique 300 of FIG. 3. For example, each of the VM templates includes the base VM template 302 and some software components may be common between some VM templates. Thus, in the described example, there may be approximately 90% similarity or other large percentage similarity between VM templates.

Therefore, embodiments that use a tree-based template structure will be described next below, wherein a base OS template is stored along with storage of software components representing the “delta” relative to the base OS template, plus storage of metadata that describes the tree structure. The nodes in the tree-based template structure contain the software components, and each node represents one of the VM templates in the set of VM templates 304 of the second technique of FIG. 2 but without storing the base VM template. Hence, since the tree-based template structure only stores the base OS template at a single base node, the software components at each child node, and the metadata (and does not store each unique VM template in the set of VM templates 304), the storage requirement for the tree-based template structure can be represented as follows in the current example wherein the software components are approximately 10% of the size of the base OS template: M+X*10%, which is considerably less storage space than M+M*(1+10%)*X of the second technique 300.

Provisioning Using Tree-Based Template Structure

FIG. 4 is a diagram illustrating a third technique 400 to provision VMs in the virtualized computing environment 100 of FIG. 1. More specifically, the third technique 400 shows a provisioning technique using a tree-based template structure approach.

As before, a base VM template 402 (e.g., a base OS template) is stored and maintained by the management server 142. Software components are available from the software repository 204, and the management server 142 (using the provisioning tool 140 of FIG. 1) may select software component from the software repository 204 to place into (e.g., to build) a tree-based template 404. Template metadata 406 includes information about the organization of the tree-based template 404, including a description of the structure of the tree-based template 404 and descriptions of the software components (e.g., services) at each node of the tree-based template 404.

In operation to generate/clone (shown at 408) each VM1 118 . . . VMX 120, the management server 142 (using the provisioning tool 140) chooses an appropriate node in the tree-based template 404 for each VM, depending on the desired role/functionality of the VM and the matching software component(s) available at the node. Since the software components are already baked in at each node of the tree-based template 404 that is selected for the VM, there is no need to perform a separate installation of the software components into each VM. The elimination of the installation process is depicted by a line 410 in FIG. 4. Thereafter, customized configuration of the software components in each VM1 118 . . . VMX 120 can be performed at 412.

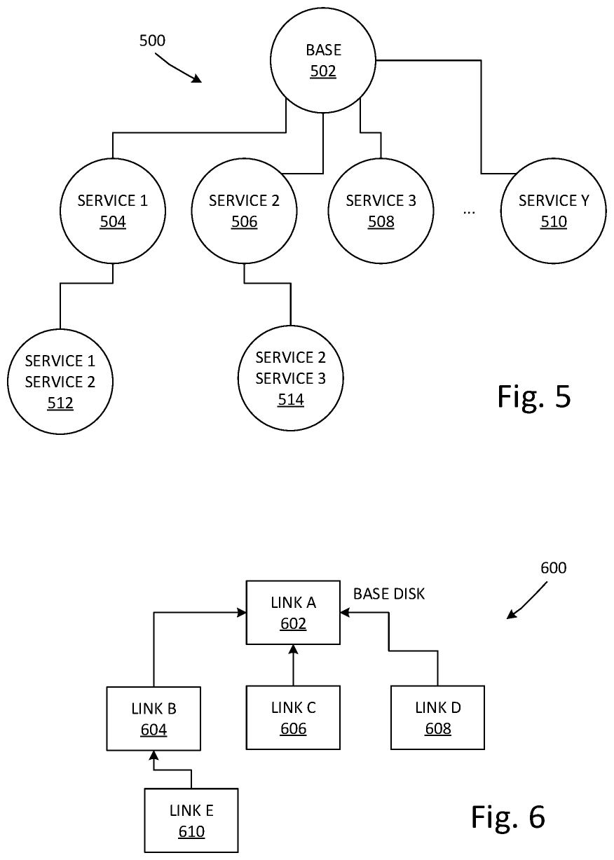

Thus, rather than having to store separate individual VM templates (like in the second technique 300 of FIG. 3), the third technique 400 enables the management server 142 to store and maintain just the tree-based template 404, and the desired provisioning for a particular VM can be performed by selecting any appropriate node in the tree-based template 404. FIG. 5 is a diagram illustrating an example topology 500 of the tree-based template 404 used in the third technique 400 of FIG. 4, including example depictions of its nodes that can be selected in order to provision a particular VM.

The tree-based template 404 having the topology 500 may be stored in one or more folders of a file system, such as a virtual machine file system (VMFS) or other type of file system in the distributed storage system 152 or other storage location in the virtualized computing environment 100. The topology 500 includes a base 502 (a base node), which may be the base VM template 402 such as a base OS template, and multiple nodes 504-514 (child nodes). The nodes 504-510 may be first-level nodes that each contain a single software component (e.g., respective individual Services 1 . . . Service Y), and the nodes 512-514 may contain combinations of two software components, of which node 512 (having Services 1 and 2) is linked to node 504 and node 514 (having services 2 and 3) is linked to node 506.

In some embodiments, the content of each node and the linking between nodes may be based on and take into consideration dependencies that may exist between the software components. For instance, there may be dependencies between Service 1 and Service 2, and so node 512 is generated to identify both of these services as belonging in the same node 512 and node 512 is linked to the parent node 504 which is in turn linked to the base node 502. Thus, if a particular VM is desired to be provisioned with both Service 1 and Service 2, the VM can be cloned from node 512 (to obtain the content for Service 2), which is linked to node 504 (to obtain the content for Service 1), and which is linked to node 502 (to obtain the content for the base OS), all of which are then combined to complete the provisioning. In an alternative embodiment, both the contents of Service 1 and Service 2 can be contained in (obtained from) the single node 512 and then combined with the base node to complete the provisioning.

According to various embodiments, the base node 502 may be stored in one base physical or logical storage device, such as a base virtual machine disk (VMDK) disk. Multiple VMDK files (each representing one of the nodes 504-514), along with the files for the template metadata 406, may be stored/maintained in the same folder as the base VMDK disk.

FIG. 6 is a diagram 600 illustrating the linking of files for a tree-based template used in the third technique 400 of FIG. 4. More specifically, the diagram 600 shows an example layout of the multiple files (such as VMDK files) that make up the tree-based template 402 and the linking between the files.

As depicted in the example of FIG. 6, the base disk (e.g., a file having the base OS template) is represented at the top of diagram 600 as Link A (602). Link B (604), Link C (606), and Link D (608) are files (for individual software components such as services) that are linked to Link A (602) and which represent child nodes of the base node at Link A (602). Link E (610) represents a child node of Link B (604) and is a file for multiple software components (services). The cloning (provisioning) of a VM can occur at any node in the diagram 600, and each node has metadata (e.g., the template metadata 406) so that the provisioning tool 140 can review the metadata at each node so as to decide which node to clone from. The management server 142 and/or the provisioning tool 140 can also use the metadata at the nodes to determine whether changes in the structure of the tree-based template 402 is needed, such as if there are dependencies that may require the re-positioning, addition, or deletion of nodes. The metadata will be described next below.

The template metadata 406 can include two types of metadata: node metadata and role metadata. The node metadata provides information about the topology details of the tree-based template 402, while the role metadata provides information about the roles (e.g., services or their functions) in each node, including information that can be used to build the tree-based template structure on demand.

The node metadata can be contained in a file or other data structure maintained for each node, and can contain information such as: a universally unique identifier (UUID) of the current node, a parent UUID of the parent node of the current node, a list of roles (e.g., services and their functions) that the current node contains, a description of the current node (e.g., comments or other information helpful information about the current node), and installation instructions (e.g., installation information that can be used to rebuild the node from its parent). For example for the installation instructions, a script can be provided for how to generate the node from the parent node.

The role metadata can contain information such as: a name of the service, a description of the service, dependencies between the service and other services, conflicts between the service and other services, installation scripts for the role, and an external location where to obtain a binary file for the service.

According to various embodiments, the node metadata and the role metadata can be statically generated during a build time of the tree-based template 404 by a build tool, or dynamically generated by the provisioning tool 140 during the process of provisioning a VM from the tree-based template 404. In the first case, only node metadata is needed, and the provisioning tool 140 can use the node metadata to provision a VM suited for the roles based on user needs. In the second case, beyond the pre-prepared nodes, the provisioning tool 140 can generate new nodes based on user requests, by using the role metadata and existing node metadata.

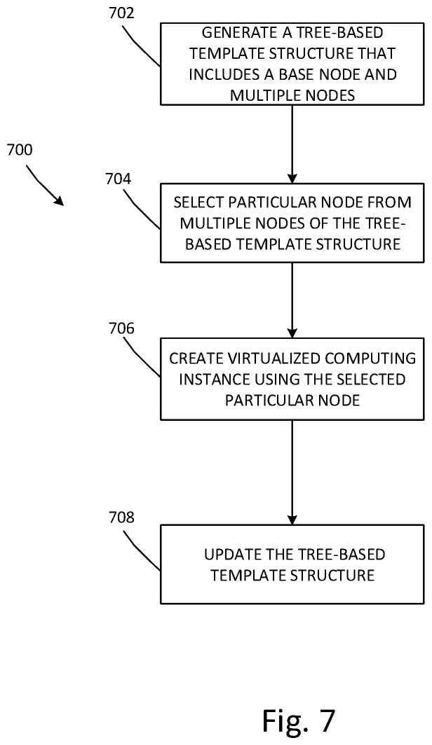

FIG. 7 is a flowchart of an example method 700 to provision VMs using a tree-based template approach. The method 700 can be implemented in the virtualized computing environment 100 in one embodiment. The example method 700 may include one or more operations, functions, or actions illustrated by one or more blocks, such as blocks 702 to 708. The various blocks of the method 700 and/or of any other process(es) described herein may be combined into fewer blocks, divided into additional blocks, supplemented with further blocks, and/or eliminated based upon the desired implementation. In one embodiment, the operations of the method 700 and/or of any other process(es) described herein may be performed in a pipelined sequential manner. In other embodiments, some operations may be performed out-of-order, in parallel, etc. At least some of the operations in the method 700 may be performed by the management server 142 in cooperation with the provisioning tool 140.

The method 700 may begin at a block 702 (“GENERATE A TREE-BASED TEMPLATE STRUCTURE THAT INCLUDES A BASE NODE AND MULTIPLE NODES”), wherein the management server 142 or other tool(s) generates the tree-based template 404. As previously explained above, the tree-based template 404 can include a base node that corresponds to the base VM template 404 and multiple nodes that are child nodes of the base node. Each of the multiple nodes can include at least one component (such as at least one service) that represents a delta relative to the base node. Thus, for example, if the base node corresponds to a base OS, then each of the multiple nodes corresponds to services that run on the base OS and that can be combined with the base OS template. The nodes may be embodied as files that are linked to each other. Generating the tree-based template structure at the block 702 can also include generating the node metadata and role metadata as described above.

The block 702 may be followed by a block 704 (“SELECT PARTICULAR NODE FROM MULTIPLE NODES OF THE TREE-BASED TEMPLATE STRUCTURE”), wherein the management server 142 determines the requirements for provisioning a particular VM and then selects a particular node in the tree-based template 404 that matches these requirements. For example, if the VM requires Service 1 and Service 2, then the node 512 in FIG. 5 can be selected by the management server 142 as the node from which to clone the VM.

Next at a block 706 (“CREATE VIRTUALIZED COMPUTING INSTANCE USING THE SELECTED PARTICULAR NODE”), the management server 142 creates the VM by combining the service(s) at the selected node with the base node. At a block 708 (“UPDATE THE TREE-BASED TEMPLATE STRUCTURE”), the management server 142 can perform any appropriate updates to the tree-based template structure, such as removing nodes, adding nodes, relocating nodes, changing the contents of nodes, etc.

Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIG. 2 to FIG. 7.

The techniques introduced above can be implemented in software. The term “processor” is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include virtual private servers, client computers, etc. The virtual machines may also be complete computation environments, containing virtual equivalents of the hardware and system software components of a physical computing system. Moreover, some embodiments may be implemented in other types of computing environments (which may not necessarily involve a virtualized computing environment), wherein it would be beneficial to organize templates for faster and more efficient provisioning as described herein.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other computer-readable instruction to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

We claim:

1. A method to provision a virtualized computing instance in a virtualized computing environment, the method comprising:
generating a tree-based template structure, wherein the tree-based template structure includes a base node and multiple nodes linked to the base node, and wherein each node of the multipole nodes includes at least one component that represents a delta relative to the base node;
selecting a particular node of the multiple nodes as a template from which to create the virtualized computing instance, wherein selection of the particular node is based on a match between a role of the virtualized computing instance and the at least one component at the particular node; and
creating the virtualized computing instance using the base node and the at least one component at the selected particular node.

2. The method of claim 1, wherein the base node comprises a template of a base operating system (OS), and wherein the at least one component includes a service that is run by the base OS.

3. The method of claim 1, wherein generating the tree-based template structure includes generating metadata that includes node metadata and role metadata.

4. The method of claim 3, wherein:
the node metadata includes information that describes a topology of the tree-based template structure and information that describes each node of the multiple nodes, and
the role metadata includes information about the at least one component at each node of the multiple nodes.

5. The method of claim 1, wherein generating the tree-based template structure includes:
storing the base node as a base disk;
storing the at least one component at each node as at least one file; and
linking the at least one file to the base disk, wherein the base disk and the at least one file are stored in a common folder along with metadata that provides information about the tree-based template structure.

6. The method of claim 1, wherein the at least one component includes a first component and a second component, and wherein creating the virtualized computing instance using the base node and the at least one component at the selected particular node includes:
obtaining the second component from the particular node;
obtaining the first component from a parent node of the particular node; and
combining the first and second components with a base component at the base node.

7. The method of claim 1, wherein the at least one component includes a first component and a second component, and wherein creating the virtualized computing instance using the base node and the at least one component at the selected particular node includes:
obtaining the first and second components from the particular node; and
combining the first and second components with a base component at the base node.

8. A non-transitory computer-readable medium having instructions stored thereon, which in response to execution by one or more processors, cause the one or more processors to perform or control performance of operations to provision a virtualized computing instance in a virtualized computing environment, the operations comprising:
generating a tree-based template structure, wherein the tree-based template structure includes a base node and multiple nodes linked to the base node, and wherein each node of the multipole nodes includes at least one component that represents a delta relative to the base node;
selecting a particular node of the multiple nodes as a template from which to create the virtualized computing instance, wherein selection of the particular node is based on a match between a role of the virtualized computing instance and the at least one component at the particular node; and
creating the virtualized computing instance using the base node and the at least one component at the selected particular node.

9. The non-transitory computer-readable medium of claim 8, wherein the base node comprises a template of a base operating system (OS), and wherein the at least one component includes a service that is run by the base OS.

10. The non-transitory computer-readable medium of claim 8, wherein generating the tree-based template structure includes generating metadata that includes node metadata and role metadata.

11. The non-transitory computer-readable medium of claim 10, wherein:
the node metadata includes information that describes a topology of the tree-based template structure and information that describes each node of the multiple nodes, and
the role metadata includes information about the at least one component at each node of the multiple nodes.

12. The non-transitory computer-readable medium of claim 8, wherein generating the tree-based template structure includes:
storing the base node as a base disk;
storing the at least one component at each node as at least one file; and linking the at least one file to the base disk, wherein the base disk and the at least one file are stored in a common folder along with metadata that provides information about the tree-based template structure.

13. The non-transitory computer-readable medium of claim 8, wherein the at least one component includes a first component and a second component, and wherein creating the virtualized computing instance using the base node and the at least one component at the selected particular node includes:
obtaining the second component from the particular node;
obtaining the first component from a parent node of the particular node; and combining the first and second components with a base component at the base node.

14. The non-transitory computer-readable medium of claim 8, wherein the at least one component includes a first component and a second component, and wherein creating the virtualized computing instance using the base node and the at least one component at the selected particular node includes:
obtaining the first and second components from the particular node; and
combining the first and second components with a base component at the base node.

15. An apparatus to provision a virtualized computing instance in a virtualized computing environment, the apparatus comprising:
a processor; and
a non-transitory computer-readable medium coupled to the processor and having instructions stored thereon, which in response to execution the processor, cause the processor to perform or control performance of operations to provision the virtualized computing instance, wherein the operations include:
generate a tree-based template structure, wherein the tree-based template structure includes a base node and multiple nodes linked to the base node, and wherein each node of the multipole nodes includes at least one component that represents a delta relative to the base node;
select a particular node of the multiple nodes as a template from which to create the virtualized computing instance, wherein selection of the particular node is based on a match between a role of the virtualized computing instance and the at least one component at the particular node; and
create the virtualized computing instance using the base node and the at least one component at the selected particular node.

16. The first node of claim 15, wherein the base node comprises a template of a base operating system (OS), and wherein the at least one component includes a service that is run by the base OS.

17. The first node of claim 15, wherein the operations to generate the tree-based template structure includes instructions to generate metadata that includes node metadata and role metadata.

18. The first node of claim 17, wherein:
the node metadata includes information that describes a topology of the tree-based template structure and information that describes each node of the multiple nodes, and
the role metadata includes information about the at least one component at each node of the multiple nodes.

19. The first node of claim 15, wherein the operations to generate the tree-based template structure includes operations to:
store the base node as a base disk;
store the at least one component at each node as at least one file; and
link the at least one file to the base disk, wherein the base disk and the at least one file are stored in a common folder along with metadata that provides information about the tree-based template structure.

20. The first node of claim 15, wherein the at least one component includes a first component and a second component, and wherein the operations to create the virtualized computing instance using the base node and the at least one component at the selected particular node includes operations to:
obtain the second component from the particular node;
obtain the first component from a parent node of the particular node; and
combine the first and second components with a base component at the base node.

21. The first node of claim 15, wherein the at least one component includes a first component and a second component, and wherein the operations to create the virtualized computing instance using the base node and the at least one component at the selected particular node includes operations to:
obtain the first and second components from the particular node; and
combine the first and second components with a base component at the base node.
